(19) United States
(12) Patent Application Publication
(10) Pub. No.: US 2004/0195265 A1
(43) Pub. Date: Oct. 7, 2004

(54) Universal delivery system for dispensing liquid adhesives

(76) Inventor: Dongmin Gu, Rockville, MD (US)

Correspondence Address: DONGMIN GU, 5440 Marinelli Rd., Apt. 225, Rockville, MD, 20852, US

(21) Appl. No.: 10/406,696

(22) Filed: Apr. 3, 2003

(51) Int. Cl. B67D 5/60

(52) U.S. Cl. 222/145.5

(57) ABSTRACT

A delivery system for dispensing liquid adhesives is disclosed. The system comprises a container for liquid adhesives; a mixing/delivering device having an initiator matrix within and optionally, a set of attachable applicators. When in use, the liquid adhesive is mixed with the initiator and optionally, a selected applicator is attached to the delivering device and the said liquid adhesive is dispensed to various substrates.

### BACKGROUND OF THE INVENTION

1. Field of the Invention

This invention relates to an improved design of delivery system for dispensing liquid adhesives on to various substrates.

2. Description of Related Art

Liquid adhesives are used in both industrial and medical applications. Included among these adhesives are cyanoacrylate monomers. They have found wide uses due to their fast cure, high strength and easy of use disclosed in U.S. Pat. Nos. 3,527,841 to Wicker et al., U.S. Pat. No. 3,722,599 to Robertson, U.S. Pat. No. 3,940,362 to Overhults, U.S. Pat. No. 3,995641 to Kronenthal et al. When used as surgical adhesives, cyanoacrylate monomers are applied to the surfaces of human tissues to be sealed or joined where polymerization is initiated and a solid film is formed providing the desired adhesive bond. When used as topical surgical adhesives, they are mostly based on alkyl cyanoacrylates, of which most are not degradable. However, selecting a proper alkyl chain of the cyanoacrylates and formulating it with stabilizers, inhibitors, plasticizers and initiators in certain cases are extremely important for obtaining desirable properties of the adhesives. It is known that short alkyl chain cyanoacrylates, such as C1-C4 alkyls, react with moisture rapidly and therefore, no initiators are needed. These materials, however, are rather brittle, limiting their use as topical surgical adhesives. Although formulating with plasticizers may improve their brittleness, the quantities needed may have effect on other physical properties of the adhesives. Some cyanoacrylates with longer alkyl chains, such as hexyl, octyl or dodecyl, have better flexibility of the polymer films. But they react rather lowly with moisture and initiators may be needed to accelerate the polymerization of the monomers, providing the desirable working time to apply the adhesives to a desired substrate. Although using initiators to accelerate polymerization of cyanoacrylate monomers is a common practice in adhesive industry, a delivery system has to be used to mix and dispense liquid adhesives as a medical device for various substrates. Various mixing/dispensing devices have been developed for the purposes of mixing multiple components simultaneously and dispensing the mixed materials. For example, U.S. Pat. No. 4,801,008 to Rich describes a disposable cartridge including a chamber containing components separated from each other by a barrier film. They may be expelled through a nozzle where they are mixed with a static mixing element.

U.S. Pat. No. 3,891,125 to Morane et al. discloses a device for storing and mixing two components prior application. One component stored in a nozzle is attached to a container of the second component. By forcing drops into the container of the second component, mixing occurs and subsequently, the mixed product is applied to a substrate.

U.S. Pat. No. 3,468,548 to Leigh describes a dispenser of two paste-like materials. One component is stored in a tube and a second material in a chamber of a nozzle attached to the tube. The first material flows through the nozzle, when forced from the tube, and mixes with the second material.

U.S. Pat. Nos. 5,928,611 and 6,099,807 to Leung et al. disclose an applicator for dispensing polymerizable materials, where initiation is induced by passing the liquid adhesives through a tip applicator containing an initiator.

### SUMMARY OF THE INVENTION

The present invention overcomes problems and disadvantages associated with current designs and strategies. The system comprises a mixing apparatus for mixing the said liquid adhesives with initiators thoroughly, an easily crushable container for the said liquid adhesives and optionally, a set of applicators of different shapes and sizes for various substrates. When in use, the said liquid adhesives are released by crushing the container and mixed thoroughly by contacting with the initiator matrix through a series of motions of passing into a mixing cup and sucking-back. The well-mixed adhesives and initiators provide well-controlled polymerization and excellent adhesive properties. Optionally, a selected applicator from the set of various shapes and sizes of the applicator tips can be attached to the delivering device for application on various substrates.

### DETAILED DESCREPTION OF PREFERRED EMBODIMENTS

Suitable materials include but not limited to ethylene derivatives, such as acrylates, cyanoacrylates; epoxy derivatives, such as epoxy or diepoxy monomers; isocynates, isoureas, carbodiimites, dialdehydes, or related polymers functionalized with these polymerizable functional groups. Especially advantageous cyanoacrylates of this invention are alkyl cyanoacrylates with a chain of up to 15 carbons; straight or branched; alkoxy derived cyanoacrylates prepared as described in U.S. Pat. No. 4,364,876 (Kimura et al.); Ester derived cyanoacrylates prepared as described in U.S. Pat. No. 3,995,641 (Kronenthal et al.) or by other preparation methods.

The adhesive formulations may include additives, such as stabilizers or polymerization inhibitors for formulation stability; plasticizers, viscosity modifiers, colorants, lubricants, mixtures thereof and other additives.

The liquid adhesive may be formulated with solvents, surfactants or other agents to achieve solution, emulsion or suspension.

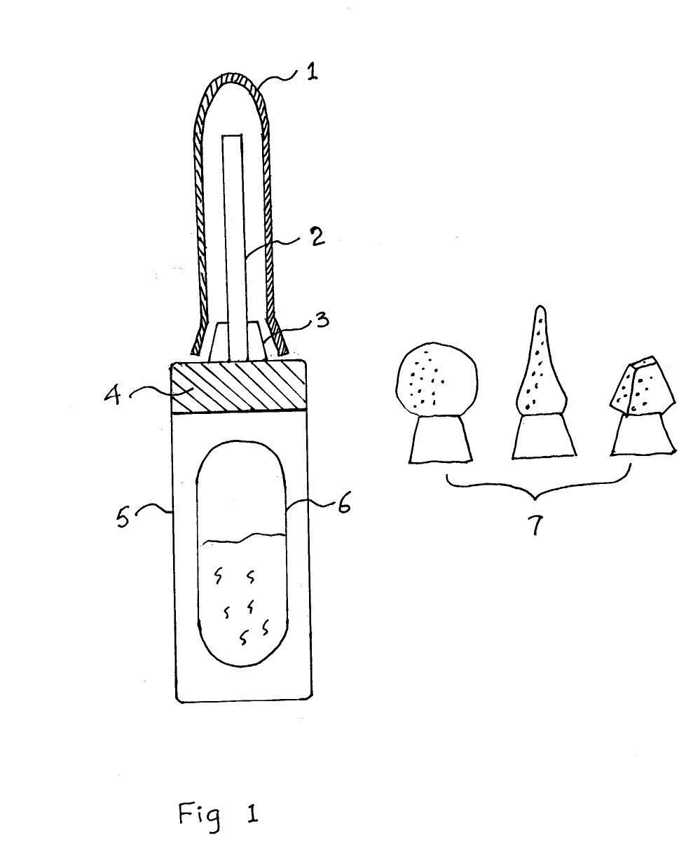

FIG. 1 illustrates the current invention. A removable mixing cup 1 and a detachable tube 2 are attached to the mixing/delivering base 3. The initiator matrix 4 is placed in the cylinder 5 which also holds the container 6 for the said liquid adhesives. Well-controlled mixing is achieved by breaking the container 6 and passing the said liquid adhesives into the mixing cup 1 and sucking it back into the cylinder 5 for several times. After removing the mixing cup 1, the adhesives are applied through the tube 2 as fine lines or various shapes by using various applicators by removing the tube 2 and replacing with an applicator selected from the group 7. The current invention provides several advantages over previous disclosures:

1) Optimal mixing of the said liquid adhesives and initiators, providing more consistent polymerization and setting time, and more importantly, reducing unreacted monomers and low molecular weight moiety; as the result of better polymerization, both mechanical and biological properties of the said liquid adhesives are greatly improved.

2) Precise application to various substrates using selected applicators.

3) Freedom of loading biologic agents or other additives to the set applicators to enhance the performance of the liquid adhesives.

What is claimed is:

1. An article of manufacture for delivering liquid adhesives, comprising a mixing/delivering device with a removable mixing cup, a breakable container for the said liquid adhesives and an initiator matrix within.

2. The article of manufacturing according to claim 1, wherein said liquid adhesives are cyanoacryates and acrylates.

3. An article of manufacture for delivering liquid adhesives, comprising a mixing/delivering device with a removable mixing cup, a removable tube and a breakable container for the said liquid adhesives and an initiator matrix within and a set of attachable applicators.

4. The article of manufacturing according to claim 3, wherein said liquid adhesives are cyanoacryates and acrylates.
